(19) United States
(12) Patent Application Publication
(10) Pub. No.: US 2007/0041166 A1
(43) Pub. Date: Feb. 22, 2007

(54) High brieghtness LED lamp

(75) Inventor: Chin-Sung Lin, Taichung County (TW)

Correspondence Address: BACON & THOMAS, PLLC, 625 SLATERS LANE, FOURTH FLOOR, ALEXANDRIA, VA, 22314, US

(73) Assignee: TERA AUTOTECH CORPORATION, TAICHUNG HSIEN (TW)

(21) Appl. No.: 11/303,976

(22) Filed: Dec. 19, 2005

(30) Foreign Application Priority Data
Aug. 22, 2005 (TW) 94214305

(51) Int. Cl. G01D 11/28

(52) U.S. Cl. 362/23

(57) ABSTRACT

An LED lamp includes a base having a receiving groove, a circuit board which is inserted through the receiving groove into the inside of the base and has two through holes, and an LED package having an LED, a shell surrounding the LED and mounted on the base, and two conductive leads electrically connected to the LED, inserted into the base and coupled respectively into the through holes of the circuit board.

### BACKGROUND OF THE INVENTION

1. Field of the Invention

The present invention relates to lamps and more particularly, to a high brightness LED lamp.

2. Description of the Related Art

Conventionally, an incandescent bulb uses a metal filament, for example, tungsten filament for giving off light upon connection of electric current. However, the brightness of the light produced through a tungsten filament is generally not enough. Further, an incandescent bulb produces much heat during the operation, and may burn out easily. Following fast development of semiconductor technology, LEDs (light emitting diodes) have been intensively sued in different fields to substitute for conventional incandescent bulbs. An LED lamp is known comprising a transparent lamp holder and an LED installed in the bottom of the lamp holder. Because the light of the LED of this design of LED lamp passes through the transparent shell of the lamp holder, the intensity of the light is greatly reduced before passing to the outside.

### SUMMARY OF THE INVENTION

The present invention has been accomplished under the circumstances in view. It is therefore the main object of the present invention to provide a high brightness LED lamp, which greatly improves the brightness of the light passing to the outside.

It is another object of the present invention to provide a high brightness LED lamp, which is easy to assemble, and practical for mass production.

To achieve these objects of the present invention, the high brightness LED lamp comprises a base having a receiving groove; a circuit board inserted through the receiving groove into the inside of the base and having two through holes; and an LED package mounted on the base. The LED package comprises an LED, a shell surrounding the LED and mounted to the base, and two conductive leads extending out of the shell. The two conductive leads are electrically connected to the LED, inserted into the base and respectively coupled into the through holes of the circuit board.

### BRIEF DESCRIPTION OF THE DRAWINGS

FIG. 1 is an exploded view of an LED lamp according to a preferred embodiment of the present invention.

FIG. 2 is a sectional assembly view of the LED lamp according to the preferred embodiment of the present invention.

FIG. 3 is an exploded view showing an application example of the LED lamp according to the present invention.

FIG. 4 is a sectional view showing the LED lamp installed in the control circuit board.

### DETAILED DESCRIPTION OF THE INVENTION

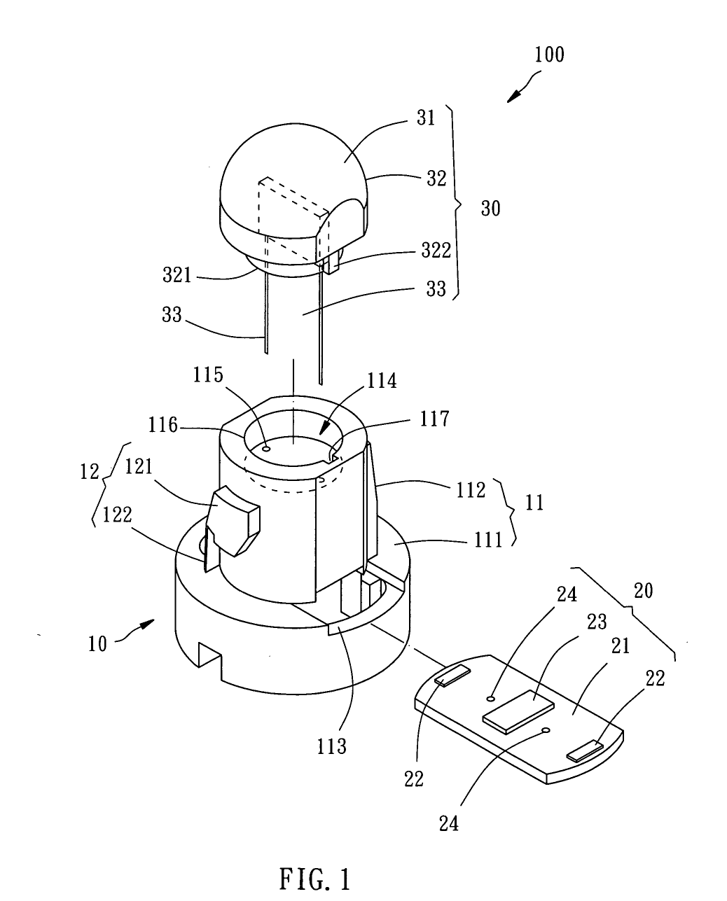

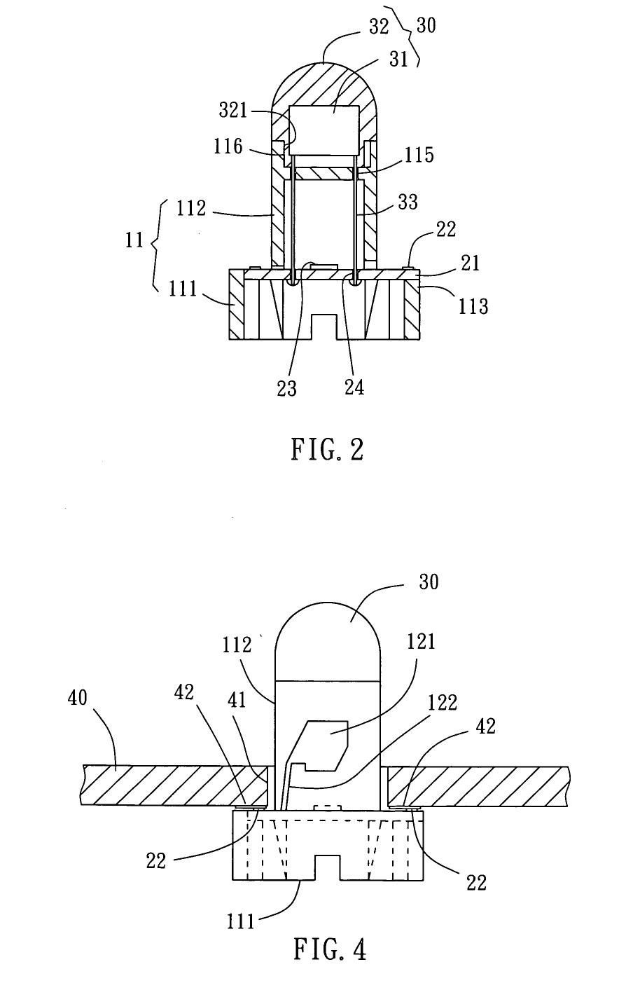

Referring to FIGS. 1 and 2, a high brightness LED lamp 100 in accordance with a preferred embodiment of the present invention is shown comprising a base 10, a circuit board 20, and an LED package 30.

The base 10 is an electrically insulative member directly molded from plastics, such as PC (polycarbonate), PE (polyethylene), PP (polypropyrene), or the like, comprising a body 11 and a coupling unit, i.e., two coupling blocks 12. The body 11 comprises a bottom block 111 and a mounting block 112. The bottom block 111 is a hollow circular block, having a receiving groove 113 formed in the top and extending horizontally. The mounting block 112 is a hollow block extending upwards from the top of the bottom block 111 over the receiving groove 113, having a receiving chamber 114 in communication with the inside of the hollow bottom block 111, two vertical through holes 115 cut through a close top wall thereof, an annular top locating flange 116 upwardly extending around the border area of the top wall, and a vertical locating groove 117 formed on the inside wall of the annular top locating flange 116. The outer diameter of the mounting block 112 is smaller than the bottom block 111. The coupling blocks 12 are respectively projected from the periphery of the mounting block 112 at two opposite sides, each comprising a retaining portion 121 and a positioning portion 122. The retaining portion 121 projects from the periphery of the mounting block 112 on the middle and spaced from the bottom block 111 at a distance. The positioning portion 122 extends downwards from one side of the retaining portion 121.

The circuit board 20 comprises a substrate 21 having a predetermined circuit layout (not shown) on the top surface thereof, two contact members 22, a resistor 23, and two through holes 24. The two contact members 22 according to this embodiment are formed of tin paste (other electrically conductive materials may be used to form the contact members 22) provided at the top side of the substrate 21 near the two distal ends and electrically connected to the circuit laid on the substrate 21. The resistor 23 can be a plug-in resistor or chip type resistor arranged on the substrate 21 and electrically connected to the circuit laid on the substrate 21 for regulating electric current and voltage passing through the circuit of the substrate 21. The through holes 24 extend through the top and bottom sides of the substrate 21, and electrically connected to the circuit laid on the substrate 21.

The LED package 30 comprises an LED (light emitting diode) 31, a transparent shell 32 surrounding the LED 31, and two conductive leads 33 respectively connected to LED 31 and extending out of the bottom side of the shell 32. The shell 32 has a bottom block 321 and a locating rib 322 protruding from the bottom block 321 at one side for engaging into the vertical locating groove 117 of the base 10.

The assembly process of the LED lamp 100 is outlined hereinafter. At first, the circuit board 20 is inserted into the horizontal receiving groove 113 of the base 10 to keep the two through holes 24 in alignment with the vertical through holes 115 and the contact members 22 disposed outside the mounting block 112, and then the bottom block 321 of the shell 32 of the LED package 30 is forced into the top recess of the base 10, which is defined by the annular top locating flange 116 and the close top wall of the base 10, to have the locating rib 322 be engaged into the vertical locating groove 117 and the conductive leads 33 be respectively inserted through the vertical through holes 115 and the through holes 24, and then the conductive leads 33 are respectively soldered to the through holes 24 to complete the assembly process.

When assembled, the LED package 30 (the LED 31) is disposed at the top side of the whole structure of the LED lamp 100, and the light of the LED 31 can directly be sent to the outside without attenuation. Further, because the periphery of the LED 31 is abutted against the transparent shell 32, the brightness of the light of the LED 31 passing through the periphery of the shell 31 is high. Further, because the conductive leads 33 of the LED package 30 are directly inserted through the vertical through holes 115 of the base 10 and the through holes 24 of the circuit board 20 and then bonded to the circuit board 20 when forcing the bottom block 321 and locating rib 322 of the LED package 30 into the top recess and vertical locating groove 117 of the base 10, the assembly process is quite simple and can be achieved by means of an automatic machine.

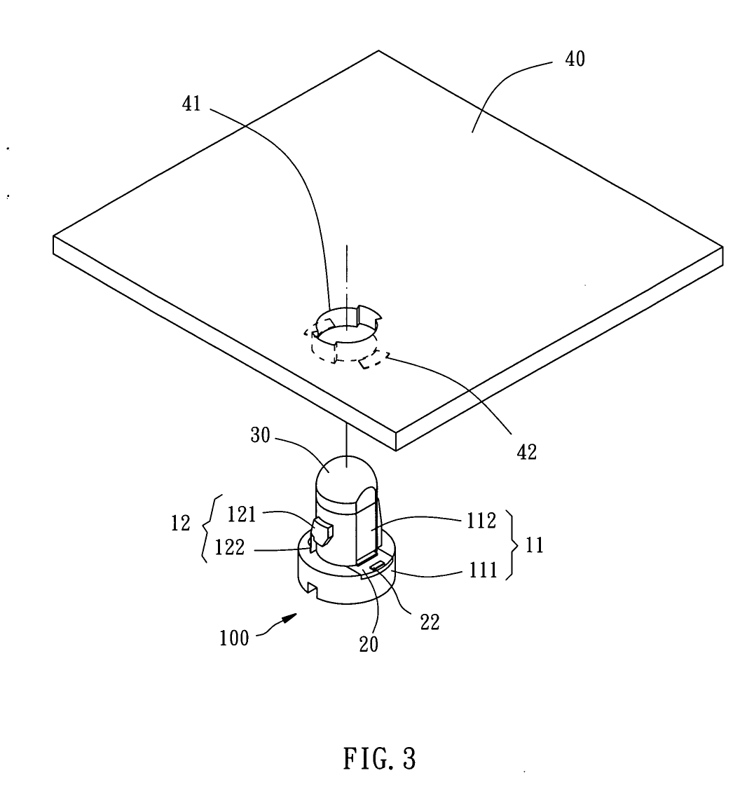

Referring to FIGS. 3 and 4, the LED lamp 100 can be installed in an external control circuit board 40. The control circuit board 40 has a mounting through hole 41, and two contacts 42 provided at the bottom wall thereof at two sides of the mounting through hole 41 and electrically connected to the circuit (not shown) of the control circuit board 40. During installation, the LED package 30 is vertically inserted with the mounting block 112 of the body 11 of the base 10 through the mounting through hole 41 of the control circuit board 40 in direction from the bottom side of the control circuit board 40 toward the top side of the control circuit board 40 to have the bottom block 111 of the body 11 of the base 10 and the circuit board 20 be stopped at the bottom side of the control circuit board 40, and then rotate the base 10 through an angle to force the retaining portions 121 of the coupling blocks 12 into engagement with the top side of the control circuit board 40 around the mounting through hole 41 and the positioning portions 122 of the coupling blocks 12 into engagement with the peripheral wall of the mounting through hole of the control circuit board 40. At this time, the contact members 22 of the circuit board 20 are respectively kept in positive contact with the respective contacts 42 of the control circuit board 40 to electrically connect the LED lamp 100 to the control circuit board 40, enabling the control circuit board 40 to control the operation of the LED lamp 100.

What is claimed is:

1. An LED lamp comprising:
a base having a receiving groove;
a circuit board inserted through said receiving groove into the inside of said base, said circuit board having two through holes; and
an LED package comprising an LED, a shell surrounding said LED and mounted to said base, and two conductive leads extending out of said shell, said conductive leads being electrically connected to said LED, inserted into said base and coupled respectively into the through holes of said circuit board.

2. The LED lamp as claimed in claim 1, wherein said base is integrally made of an electrically insulative material.

3. The LED lamp as claimed in claim 1, wherein said base comprises a body, said body comprising a hollow bottom block having said receiving groove formed in a top wall thereof, and a mounting block extending upwards from said hollow bottom block over said receiving groove and having a receiving chamber in communication with the inside of the hollow bottom block for enabling the conductive leads of said LED packages to pass to the through holes of said circuit board.

4. The LED lamp as claimed in claim 3, wherein the mounting block of said body has a top wall with two through holes for the passing of the conductive leads of said LED package.

5. The LED lamp as claimed in claim 3, wherein the mounting block of said body comprises a top locating flange having a locating groove; said shell of said LED package has a bottom block engaged with the top locating flange, and a locating rib projecting from the bottom block and engaged into the locating groove of the mounting block of said body.

6. The LED lamp as claimed in claim 3, wherein said base further comprises a coupling unit for securing said body to an external device, said coupling unit comprising two coupling blocks respectively projected from the periphery of the mounting block of said body at two opposite sides, said coupling blocks each comprising a retaining portion projecting from a middle part of the periphery of the mounting block of said body and spaced above the bottom block of said body at a distance, and a positioning portion downwardly extending from one side of said retaining portion.

7. The LED lamp as claimed in claim 1, wherein said circuit board comprises a substrate on which a predetermined circuit is laid, two contact members arranged on a top wall of said substrate and electrically connected to the circuit of said substrate for electrically connecting an external element, a resistor arranged on said substrate and electrically connected to the circuit of said substrate for regulating electric current and voltage passing through the circuit of said substrate, and said two through holes formed in the substrate and electrically connected to the circuit of said substrate.

8. The LED lamp as claimed in claim 7, wherein said contact members are formed of tin paste.
